(19) United States
(12) Patent Application Publication
(10) Pub. No.: US 2006/0082905 A1
(43) Pub. Date: Apr. 20, 2006

(54) Catadioptric projection objective with an in-line, single-axis configuration

(76) Inventors: David R. Shafer, Fairfield, CT (US); Alexander Epple, Oberkochen (DE); Wilhelm Ulrich, Aalen (DE)

Correspondence Address: DARBY & DARBY P.C., P. O. BOX 5257, NEW YORK, NY, 10150-5257, US

(21) Appl. No.: 10/965,664

(22) Filed: Oct. 14, 2004

(51) Int. Cl. G02B 17/00

(52) U.S. Cl. 359/727

(57) ABSTRACT

A catadioptric objective for a microlithography projection system has an in-line single-axis arrangement of lenses and reflectors. The catadioptric portion of the objective includes a catadioptric lens element with at least one reflective surface or surface portion reflecting light back into the lens, so that the catadioptric lens element interacts with light rays through reflection as well as refraction.

### BACKGROUND OF THE INVENTION

The invention relates to a catadioptric projection objective for a microlithographic exposure apparatus used in producing microstructured devices such as integrated circuits or other semiconductor devices. Such devices are fabricated in a photolithography process in which a mask (also referred to as reticle) representing a microstructured circuit pattern is positioned in the object plane of a projection objective. A reduced copy of the pattern is produced photographically on a semiconductor wafer positioned in the image plane of the projection objective.

In order to obtain the highest possible image resolution in the reproduction of the microscopically fine structures, it is desirable to increase the numerical aperture on the image side of the projection objective and to employ light of a shorter wavelength, preferably in the ultraviolet range of the spectrum with wavelengths that are typically shorter than about 260 nanometers.

However, only very few lens materials are sufficiently transparent to ultraviolet light at wavelengths shorter than 260 nm. The selection of materials for lenses in microlithography objectives is therefore severely limited and includes in particular synthetic quartz glass and crystalline fluorides such as calcium fluoride, barium fluoride, magnesium fluoride, lithium-calcium-aluminum fluoride, lithium-strontium-aluminum fluoride, lithium fluoride, and similar materials. Given that the Abbe numbers of the available materials differ from each other only within a narrow range, it is difficult to design purely refractive systems that are sufficiently corrected for chromatic aberrations. Although the problem could at least in theory be solved by employing purely reflective systems instead of lenses, this solution is not practically feasible because of the cost and complexity involved in fabricating the mirror systems.

Catadioptric objectives, i.e., optical systems that use both lenses and mirrors in combination, have been developed as a practical solution to the problems that are inherent in purely refractive or purely reflective objectives. The mirrors in a catadioptric objective are required for the chromatic correction and for the correction of the field curvature. As a specific advantage of catadioptric objectives, concave mirrors can replace the refractive power of lenses without simultaneously generating chromatic aberrations. If lenses were used instead of the mirrors, the lenses would generate a strong longitudinal chromatic aberration because the refractive index of the glass material depends on the wavelength. In other words, the refractive power of a lens depends to some extent on the color of the light. The classical approach to designing a color-corrected objective is to use lenses of different materials in a suitable combination, so that the chromatic aberrations of the lenses cancel each other at least approximately. However, this solution is not available for microlithography objectives, due to the limited choice of lens materials that have the required transparency for short wavelengths. Thus, catadioptric objectives are characteristically used in microlithography projection systems operating at short wavelengths.

A first class of catadioptric objectives, referred to as on-axis objectives, is disclosed in U.S. Pat. No. 6,169,627, U.S. Pat. No. 6,313,467, and EP 1 098 215. On-axis objectives are characterized by the fact that their object field lies on the optical axis. However, objectives that are configured according to the aforementioned references have the drawback that the mirrors have holes for the light path to pass through, so that the pupil image has a linear obscuration of at least 15% at the center. The linear obscuration is defined as the ratio between the marginal ray height and the half-diameter of the central obscuration.

Catadioptric objectives of another class, referred to as beam splitter designs or BSC designs, are disclosed in US 2002/0167737 and WO 03/027747. BSC objectives have a so-called beam splitter cube (BSC) as their distinguishing characteristic. The beam splitter cube has a beam-splitting boundary layer whose optical properties are polarization-dependent. The beam-splitting effect is achieved by rotating the linear polarization of a light beam by 90° between a first and second incidence on the boundary layer, so that the boundary layer reflects the incident light in one case and transmits it in the other case. The fact that the optical axis is broken up in different directions is seen as a disadvantage of the BSC objectives according to US 2002/0167737 and WO 03/027747.

The foregoing discussion of the background of the present invention, the selection of references cited and the observations made in regard to the references reflect a current level of technical understanding. No admission is expressed or implied that any of the information presented above belongs to the state of the art. The foregoing information is presented in good faith, and no representations are made in regard to its completeness and correctness.

### OBJECT OF THE INVENTION

The object of the present invention is to provide catadioptric microlithography projection objectives for use with ultraviolet light at wavelengths shorter than 260 nm, meeting the requirements that the obscuration is significantly smaller than 15% and that the optical elements of the objective are arranged in an in-line, single-axis configuration.

### SUMMARY OF THE INVENTION

A catadioptric microlithographic projection objective according to the present invention directs light along a light path from an object plane to an image plane. In view of the fact that the light path reverses direction at the reflecting elements inside the inventive catadioptric objective, the term “forward” will hereinafter be used to indicate a sense of direction, orientation, or sequence of arrangement from the object plane to the image plan, while the term “backward” will be used for the reverse sense of direction. The inventive objective includes at least the following optical elements, arranged in the following sequential order relative to the forward direction of the objective:
a first optical subsystem with a plurality of lenses;
a second optical subsystem which includes a concave mirror with its concave reflecting surface facing in the forward direction and with a central passage opening for the light path, and which further includes a catadioptric lens element with a first surface nearer to the object plane and a second surface nearer to the image plane,
a third optical subsystem with at least one lens.

The term “catadioptric lens element” as used above and hereinafter refers to an optical element that includes at least one body of refractive material bounded by opposed refracting surfaces, where at least one of the refracting surfaces has at least a surface part with a substantial degree of reflectivity which is used to influence or direct the path of imaging light rays traveling through an objective containing a catadioptric lens. A Mangin mirror, as normally understood, represents a typical example of a catadioptric lens element.

It should be emphasized that the substantial degree of reflectivity present in a catadioptric lens element is of a higher order of magnitude than the reflection that occurs together with a refraction at any refracting surface in accordance with the laws of physics. As a standard practice, this latter kind of reflection, which is only producing stray light and other non-desired effects, is effectively countered by anti-reflection coatings. In contrast, the reflection taking place in a catadioptric lens element is an intended effect that is used for a specific purpose in the imaging function performed by the objective that contains the catadioptric lens element.

Thus, the catadioptric lens element interacts with light rays through refraction as well as reflection. In the catadioptric lens element that is part of the catadioptric microlithographic projection objective according to the present invention as described above, the second surface reflects at least a part of the light, and the way in which the reflection is used is analogous to a mirror.

Light rays originating from a point in the object plane and propagating along the light path pass through the first optical subsystem and the central passage opening of the concave mirror. The light rays continue from the central passage opening until they enter the catadioptric lens element through its first surface. In a first incidence on the second surface, the light rays are at least partially reflected. The reflected light rays travel substantially in the backward direction, leaving the lens again through the first surface and continuing until they are reflected by the concave mirror. Now traveling again in a substantially forward direction, the light rays pass a third time through the catadioptric lens element. In a second incidence on the second surface, the light rays are at least partially transmitted by the second surface and subsequently focused by the third optical subsystem of the objective to form an image in the image plane.

Preferred embodiments of the invention may have one or more of the following distinguishing characteristics:
The optical elements of the objective are aligned and centered on a single, unbroken optical axis.
The first and/or third subsystems preferably consist of refractive optical elements.
The first optical subsystem forms an intermediate image substantially at the central passage opening of the concave mirror.
The second surface of the catadioptric lens element is coated with a beam splitter coating.

In further embodiments, the inventive catadioptric objective may be expanded with additional imaging subsystems in the imaging light path that extends from the object plane to the image plane. In particular, a first additional imaging subsystem could be arranged between the object plane and the first optical subsystem, and/or a second additional imaging subsystem could be arranged between the third optical subsystem and the image plane. In this arrangement, the first additional imaging subsystem forms a first additional intermediate image in an intermediate image plane located in the imaging light path ahead of the first optical subsystem. The second additional imaging subsystem projects a second additional intermediate image (which follows in the imaging light path after the third optical subsystem) into the image plane.

The catadioptric lens element is preferably a lens of negative refractive power. As mentioned, in an arrangement of the foregoing description where the beam splitter coating is applied to the second surface of the catadioptric lens element, the latter is traversed three times by the same light rays. The placement of the catadioptric lens element near the pupil, the large marginal ray height, and in particular the fact that the light traverses the catadioptric lens element three times, are significant factors that are conducive to achieving a good correction of the axial chromatic aberrations.

Preferably, the at least partial reflection at the beam splitter coating is a substantially total reflection, and the at least partial transmission is a substantially total transmission.

In a practical embodiment of the inventive catadioptric objective, the beam splitter coating is a so-called 50-percent beam splitter coating, meaning that in each incidence substantially one half of the light is transmitted and one half is reflected (if losses due to absorption and dispersion are disregarded). Consequently, after meeting the beam splitter coating twice, substantially 25 percent of the light originating from the point in the object plane reaches the image plane.

In a further practical embodiment of the catadioptric objective according to the invention, the second surface of the catadioptric lens element has a central light barrier, also referred to as a black spot, to prevent that any of the light that passes through the beam splitter coating at the first incidence could fall directly on the image plane.

Further, to prevent stray light from falling on the peripheral areas of the image field, embodiments of the inventive catadioptric objective are advantageously equipped with a peripheral light barrier between the third optical subsystem and the image plane. The shape and dimensions of this peripheral light barrier are advantageously coordinated with the shape and dimensions of the aforementioned central light barrier.

Preferred embodiments of the objective according to the invention have an aperture stop, also referred to as system diaphragm, in the first optical subsystem. However, it is also conceivable to arrange the system diaphragm in the second optical subsystem. If the system diaphragm is arranged in the second optical subsystem, the preferred location is next to the concave mirror. Preferably, a system diaphragm next to the concave mirror has a substantially spherical shape and is centered on the curvature center of the concave mirror.

Regardless of its location within the system, the aperture stop serves to define or modify the numerical aperture of the system.

Preferably, the concave mirror is arranged at or near a point of the optical axis that is conjugate to the location of the system diaphragm.

According to a particularly preferred embodiment of the invention, all of the refractive parts of the catadioptric objective, i.e., the plurality of lenses of the first optical subsystem, the catadioptric lens element, as well as the at least one lens of the third optical subsystem are made of one and the same lens material.

In preferred embodiments of the invention, at least some of the lenses among the plurality of lenses of the first optical subsystem, the catadioptric lens element, and the at least one lens of the third optical subsystem are made of a crystalline material. A preferred choice for the crystalline lens material is calcium fluoride (CaF₂) Other preferred embodiments, which are not shown here, have lenses of fused silica (SiO₂).

Preferred embodiments of the objective according to the invention operate with non-polarized ultraviolet light at wavelengths shorter than 260 nm, specifically at an operating wavelength of 193 nm or 157 nm.

Preferred embodiments of the inventive catadioptric objective of in-line single axis configuration are further distinguished by the fact that their linear central obscuration is significantly smaller than 15%, typically no more than 12%.

The catadioptric objective of the foregoing description could also be configured as an immersion system, i.e., with a refractive fluid arranged in the interval that separates the objective from the image plane. This offers the possibility to realize a numerical aperture larger than 1.0.

A further catadioptric projection objective according to the present invention includes the following optical elements, named in sequential order relative to the forward direction of the objective:
a first optical subsystem which can be configured as a purely refractive subsystem with a plurality of lenses, or as a catadioptric or catoptric subsystem; and
a second optical subsystem, also referred to as a catadioptric portion, represented by a first Mangin lens with a first surface nearer to the object plane followed immediately by a second Mangin lens with a second surface nearer to the image plane. The first surface is convex and has a first inward-reflecting mirror portion and a first light-transmitting portion, while the second surface has a second inward-reflecting mirror portion and a second light-transmitting portion.

The first and second Mangin lenses form a catadioptric portion or subsystem of the objective in the sense that they interact with light rays through refraction as well as reflection. Specifically, the Mangin lenses used in the catadioptric objective of the present invention have mirror-coated surface portions that are reflective towards the inside of the lenses and are referred to herein as inward-reflecting mirror portions. The surface areas of the lenses that are not covered by the mirror coating are referred to as light-transmitting portions.

In the objective of the foregoing description, light rays originating from a point in the object plane and propagating along the light path are focused by the first optical subsystem. The light rays enter the first Mangin lens through the first light-transmitting portion, pass through the first and second Mangin lenses, and are reflected back into the second Mangin lens by the second inward-reflecting mirror portion. After traveling substantially backwards through the first and second Mangin lenses, the light rays are reflected by the first inward-reflecting mirror portion, so that they pass a third time through both Mangin lenses and then leave the second Mangin lens through the second light-transmitting portion. As a combined result of the reflection and refraction taking place in the Mangin lenses, the light rays leaving the second Mangin lens are focused so that they form an image in the image plane.

Preferred embodiments of the invention may have one or more of the following distinguishing characteristics:
The optical elements of the objective are aligned and centered on a single, unbroken optical axis.
The first subsystem preferably consists of refractive optical elements.
The first optical subsystem forms an intermediate real image substantially near the first light-transmitting portion of the first Mangin lens.

It should be noted that the inward-reflecting portions of the Mangin lenses reflect substantially 100 percent of the incident light, while the light-transmitting portions transmit substantially 100 percent of the incident light.

With preference, at least one of the two Mangin lenses is a lens of positive refractive power.

Under a particularly preferred embodiment of the foregoing concept, the two Mangin lenses of the second optical subsystem are joined or combined into a single Mangin lens, preferably of positive refractive power.

A catadioptric objective based on the aforedescribed inventive concept of using either a single (combined) Mangin lens or two separate Mangin lenses can be operated with a ring field, meaning that a ring-shaped area of the object plane is projected into a ring-shaped area of the image plane.

Preferred embodiments of the catadioptric objective with either a single Mangin lens or two separate Mangin lenses have a numerical aperture of at least 0.7.

If the catadioptric objective of the foregoing description is configured as an immersion system, i.e., with a refractive fluid arranged in the interval that separates the objective from the image plane, it is possible to realize a numerical aperture larger than 1.0.

An aperture stop can advantageously be arranged in the first optical subsystem of a catadioptric objective according to the invention.

In a practical embodiment of the inventive catadioptric objective with one or two Mangin lenses, the first optical subsystem has an image reduction of the order of 2×, and the second optical subsystem represented by the one or two Mangin lenses has an image reduction of the same order of magnitude, resulting in a total reduction of the order of 4× for the entire catadioptric objective.

In more specific terms, if an overall system magnification is defined as β and a refractive magnification contributed by the first optical subsystem is defined as β₁, the absolute value of β₁/β is in the range 4/3<|β₁/β|<3.

According to a particularly preferred embodiment of the invention, all of the refractive parts of the catadioptric objective, i.e., the plurality of lenses of the first optical subsystem as well as the one or two Mangin lenses of the second optical subsystem are made of one and the same lens material.

In preferred embodiments of the invention, at least some of the lenses among the plurality of lenses of the first optical subsystem and the one or two Mangin lenses of the second optical subsystem are made of the same material. Preferred choices for the lens material are crystalline calcium fluoride (CaF₂) or fused silica (SiO₂).
Preferred embodiments of the objective according to the invention operate with non-polarized ultraviolet light at wavelengths shorter than 260 nm. Specifically preferred are operating wavelengths of substantially 193 nm or substantially 157 nm.

In further embodiments, the inventive catadioptric objective may be expanded with additional imaging subsystems in the imaging light path that extends from the object plane to the image plane. In particular, a first additional imaging subsystem could be arranged between the object plane and the first optical subsystem, and/or a second additional imaging subsystem could be arranged between the second optical subsystem and the image plane. In this arrangement, the first additional imaging subsystem forms a first additional intermediate image in an intermediate image plane located in the imaging light path ahead of the first optical subsystem. The second additional imaging subsystem projects a second additional intermediate image (which follows in the imaging light path after the second optical subsystem) into the image plane.

### BRIEF DESCRIPTION OF THE DRAWINGS

Preferred embodiments of the invention are described hereinafter with reference to the drawings, wherein:

FIG. 1 illustrates a first embodiment of a catadioptric objective according to the invention,

FIG. 2 illustrates a second embodiment of a catadioptric objective according to the invention,

FIG. 3 illustrates the paths of light rays through a Mangin lens according to the invention, and

FIG. 4 illustrates a variation of the catadioptric objective of FIG. 2.

FIG. 5 illustrates the possibility of expanding a catadioptric objective with a first and/or second additional imaging subsystem.

### DESCRIPTION OF PREFERRED EMBODIMENTS

In the catadioptric objectives described below and illustrated in the drawings, the object plane and the image plane of the objective are represented, respectively, by the planes of the reticle pattern and the wafer surface. However, the invention could also be embodied in an objective that is integrated in a larger objective system in which the object plane and/or the image plane of the inventive objective represent intermediate image planes of the larger overall objective system.

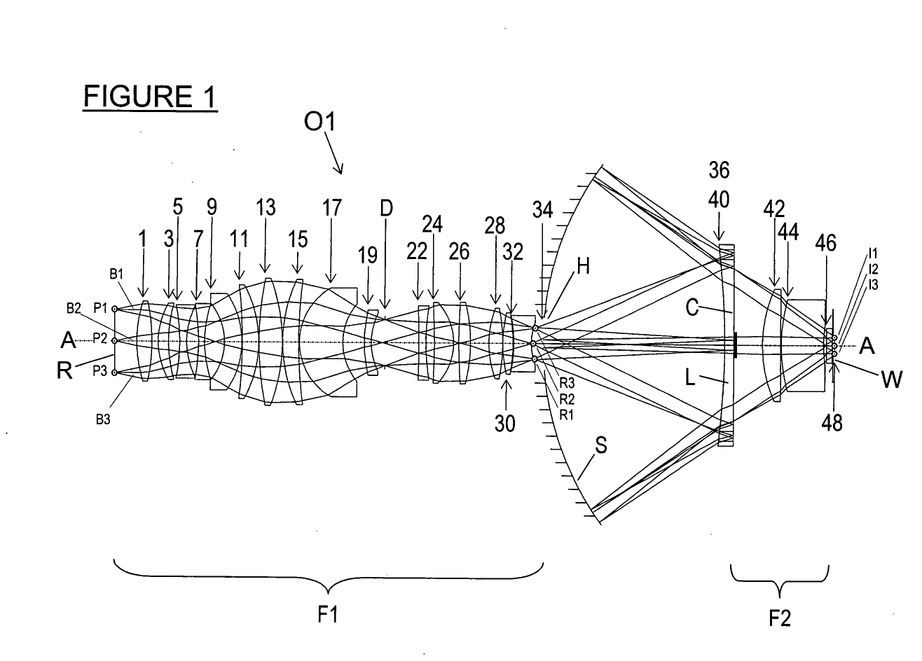

FIG. 1 illustrates a catadioptric projection objective O1 according to the invention. All elements of the objective, i.e., the lenses of the first optical subsystem F1, the concave mirror S, the lens L with the beam splitter coating, and the third optical subsystem F2 are aligned and centered on the optical axis represented by the line A-A in FIG. 1. A micro-structured mask R (also referred to as a reticle R) is arranged in the object plane, and a wafer W with a light-sensitive coating is arranged in the image plane of the catadioptric objective. The reference symbols 1 to 48 in FIG. 1 correlate to the numbers in the first column of Table 1 and identify the optical surfaces in the order in which they are met or traversed by the light rays traveling through the objective O1. Consequently, if a surface is met or traversed more than once by the light rays, the same surface is listed again with the appropriate reference numbers for the second and third passage of the light. For example, the surface 36 of the lens L is listed again with the reference numbers 38 and 40, due to the fact that this same surface is traversed three times by a light beam, as will be explained below. However, so as not to unnecessarily clutter the drawing, not all of the numbers in column 1 of Table 1 are shown in FIG. 1.

FIG. 1 schematically illustrates how the objective O1 projects light from exemplary points P1, P2, P3 of the reticle R in the object plane to form an image I, I2, I3 on the wafer surface in the image plane. Bundles of light rays B1, B2, B3 originate, respectively, from points P1, P2, P3 of the object plane and converge after the first optical subsystem F1 to form a real intermediate image R1, R2, R3 substantially in the central passage opening H of the mirror S. On their way through the first optical subsystem F1, the light bundles B1, B2, B3 are peripherally delimited by an aperture stop D (also referred to as a system diaphragm D). In the illustrated example, the system diaphragm is arranged at or near an axial position that is conjugate to the axial position of the concave mirror S. The light rays continue from the central passage opening H until they enter the catadioptric lens element L which has a beam splitter coating C on its backside, i.e., on the side that faces towards the image plane with the wafer W. In a first incidence on the beam splitter coating C, the light rays are at least partially reflected back through the lens L to the concave mirror S, meeting the mirror surface in a quasi-normal incidence. After a substantially normal reflection at the concave mirror S, the light rays pass a third time through the catadioptric lens element L. In a second incidence on the beam splitter coating C, the light rays are at least partially transmitted by the beam splitter coating and are subsequently focused by the third optical subsystem F2 of the objective O1 to form the image I1, I2, I3 on the surface of the wafer W in the image plane of the objective.

The catadioptric objective O1 of FIG. 1 has two properties that are significant for the chromatic correction:
1. In the first refractive portion of the objective O1, there is only a small amount of positive refractive power at large marginal ray heights. As a result the axial chromatic aberration is moderately undercorrected by the refractive part of the objective O1.
2. The negative refraction in the catadioptric lens element L at a large marginal ray height causes a strong chromatic overcorrection. Through appropriate design choices, the chromatic overcorrection in the catadioptric lens element can be adjusted to have substantially the same absolute magnitude as the undercorrection of the refractive part.
   The longitudinal chromatic aberration CHL can thus be corrected through a design in which the overcorrection of the catadioptric lens element compensates for the undercorrection of the refractive part.

The transverse chromatic aberration CHV can be corrected through an appropriate distribution of the refractive power in the first and third optical subsystems F1 and F2 of the objective O1.

Higher-order chromatic aberrations, among them in particular spherochromatism, occur only to a very minor extent, because the chromatic correction as well as the correction of the spherical aberration are made at the same place in the objective (i.e., through the refractive power of the catadioptric lens element L and through the refraction at the front surface of the lens, meaning the surface that faces towards the object plane).

In general terms, a design according to the invention and configured like the example of FIG. 1 offers the potential for high numerical aperture values (NA>0.9) with a degree of correction that is customary in lithography systems, i.e., with an rms-variation of the wave front of less than 3/1000 of the wavelength. The objective of FIG. 1 with the specific design data of Table 1 has a numerical aperture of 0.85.

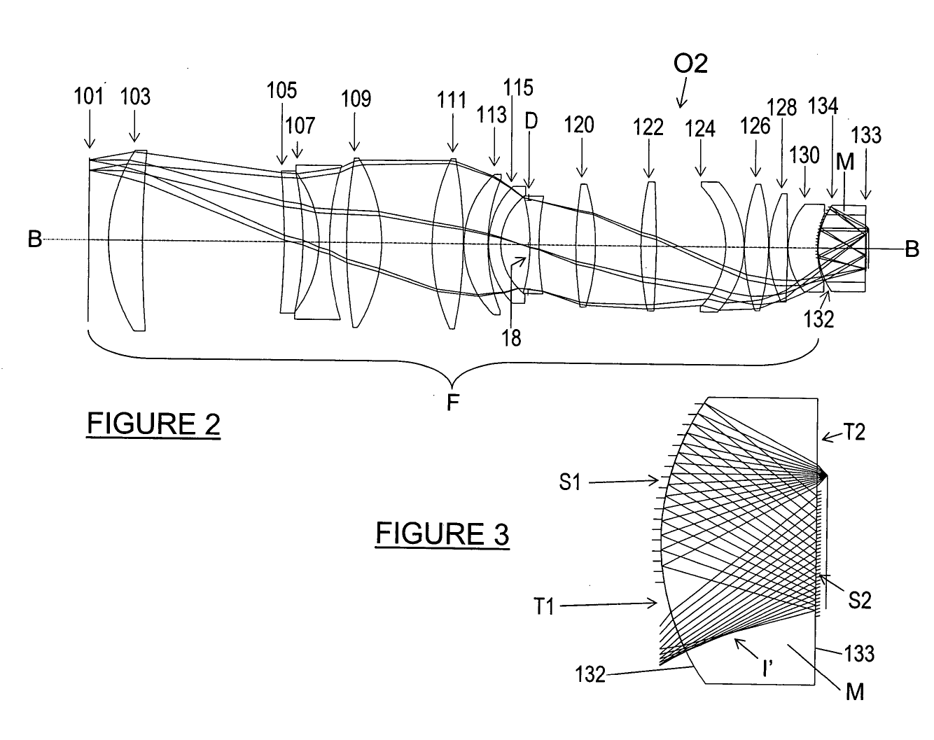

The catadioptric projection objective O2 shown in FIG. 2 with design data listed in Table 2 likewise has a single, unbroken optical axis represented by the line B-B. In the light path from the object plane to the image plane, a refractive portion F of the objective O2 is followed by a catadioptric portion, which is represented by a Mangin lens M with a convex first surface 132 facing towards the refractive portion and a second surface 133 facing towards the image plane. The first surface 132 has a first inward-reflecting mirror portion S1 and a first light-transmitting portion T1, while the second surface has a second inward-reflecting mirror portion S2 and a second light-transmitting portion T2. Analogous to FIG. 1, the reference symbols 101 to 133 in FIG. 2 correlate to the numbers in the first column of Table 2 and identify the optical surfaces in the order in which they are traversed by light rays traveling through the objective O2. Also analogous to FIG. 1 and Table 1, a surface that is met or traversed more than once by the light rays is listed again with the appropriate sequential reference number for each following passage of the light. However, so as not to unnecessarily clutter the drawing, not all of the numbers in column 1 of Table 2 are shown in FIG. 2.

In the objective of FIG. 2, light rays originating from points in the object plane 101 and propagating along the light path are focused by the refractive portion F to form an intermediate real image near the first light-transmitting portion T1 (see FIG. 3) of the Mangin lens M. The light rays enter the Mangin lens M through the first light-transmitting portion T1, pass through the Mangin lens M to the second inward-reflecting mirror portion S2 from where the light rays are reflected back through the Mangin lens onto the first inward-reflecting mirror portion S1, where they are reflected again so that they pass a third time through the Mangin lens and then leave the Mangin lens through the second light-transmitting portion T2. As a combined result of the reflection and refraction taking place in the Mangin lens, the light rays leaving the Mangin lens are focused so that they form an image in the image plane.

FIG. 3 represents a magnified detail view of the Mangin lens of FIG. 2. The light rays originating from a single point in the object plane (to the left and outside of the part shown in FIG. 3) intersect each other to form an intermediate real image I′ in the general area of the first light-transmitting portion T1 of the Mangin lens. However, as the representation of FIG. 3 illustrates, the light rays are not intersecting in a sharply defined point, so that the intermediate image I′ is highly aberrated. After traversing the Mangin lens, the light rays are reflected at the second inward-reflecting mirror portion S2, traverse the lens in the backward direction, are reflected at the first inward-reflecting mirror portion S1, traverse the lens again in the forward direction, exit from the lens through the second light-transmitting portion T2 and are focused on the image plane.

Compared to an all-refractive projection objective the axial color correction is improved, although the aberration is not fully corrected. The improvement is mainly the result of two factors:
1. the refractive portion which forms the intermediate image does not produce the entire amount of image reduction. Thus, the refractive portion does not have as much refractive power as a classical refractive objective.
2. The final portion of the optical reduction occurs mainly by reflection at the first surface of the thick Mangin lens and thus does not add to the axial color aberration. Furthermore, the Mangin lens provides a degree of correction for the axial chromatic aberration, due to the finite thickness of the Mangin lens in combination with the large ray height.

The lens design of the system benefits from the high level of Petzval-sum correction produced by the strong curvature of the first inward-reflecting portion. As a consequence, the system is distinguished by an absence of pronounced waists in the refractive portion of the objective.

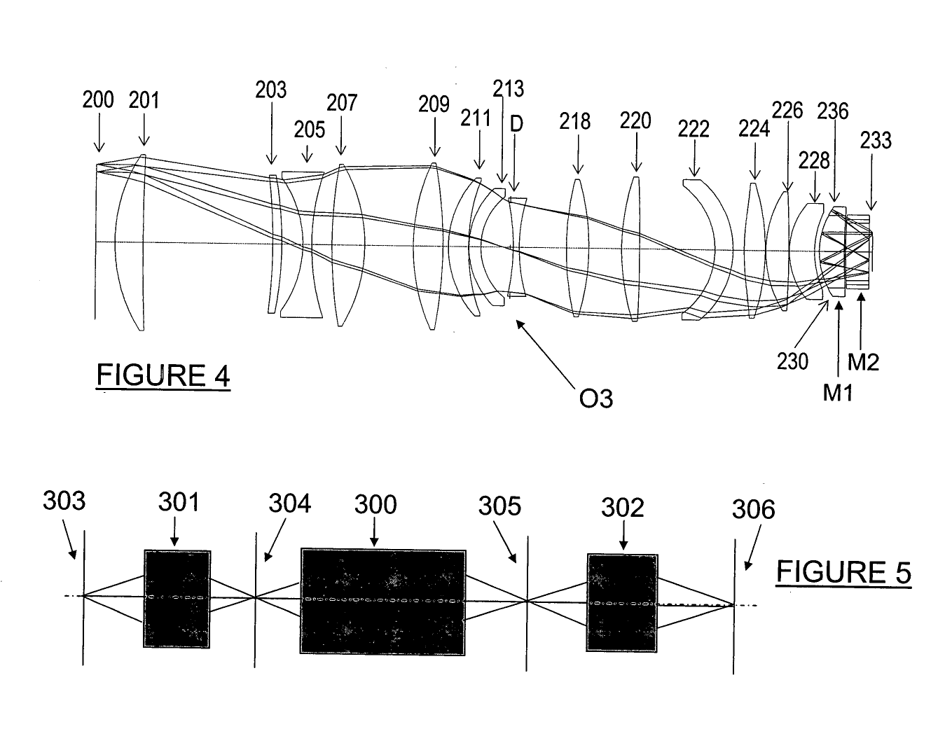

The catadioptric projection objective O3 shown in FIG. 4 with the design data tabulated in Table 3 represents a variation of the Mangin-lens concept. In the light path from the object plane to the image plane, a refractive portion with the lenses 201 to 228 of the objective O3 is followed by a catadioptric portion, which is represented by two Mangin lenses M1 and M2. The first Mangin lens M1 has a convex first surface 230 facing towards the refractive portion, while the second Mangin lens M2 has a second surface 233 facing towards the image plane. The first surface 230 has a first inward-reflecting mirror portion S1 and a first light-transmitting portion T1 analogous to the first surface 132 in FIG. 3, while the second surface 233 has a second inward-reflecting mirror portion S2 and a second light-transmitting portion T2 analogous to the second surface 133 in FIG. 3. As explained in the context of FIGS. 1 and 2, the reference symbols 200 to 233 in FIG. 4 correlate to the numbers in the first column of Table 3 and identify the optical surfaces in the order in which they are met or traversed by light rays traveling through the objective O3. Also analogous to FIGS. 1 and 2 as well as Tables 1 and 2, a surface that is met or traversed more than once by the light rays is listed again with the appropriate sequential reference number for each following passage of the light. However, so as not to unnecessarily clutter the drawing, not all of the numbers in column 1 of Table 3 are shown in FIG. 4.

In principle, the objective O3 of FIG. 4 differs from the objective O2 of FIG. 2 only insofar as the objective O3 uses two Mangin lenses M1 and M2 to perform the same function as the single Mangin lens M of FIG. 2. One could consider the Mangin lenses M1 and M2 as the result of splitting the single Mangin lens M in two, or conversely, the single Mangin lens M can be seen as the result of joining or combining the two Mangin lenses M1 and M2 into one lens.

FIG. 5 illustrates the possibility of expanding a catadioptric objective 300 according to one of the FIGS. 1, 2 or 4 with a first additional imaging subsystem 301 and/or a second additional imaging subsystem 302. The first additional imaging subsystem 301, arranged between the object plane 303 and the objective 300 forms a first additional intermediate image in an intermediate image plane 304 located in the imaging light path ahead of the objective 300. The second additional imaging subsystem 302, arranged between the objective 300 and the image plane 306 projects a second additional intermediate image from a second additional intermediate image plane 305 into the image plane 306.

TABLE 1
Design Data for the Objective of FIG. 1
Wavelength 157.6 nm

| Surface | Radius | Thickness | Glass | Semidiameter |
|---|---|---|---|---|
| 1 | 229.515299 | 25.221175 | CAF2 | 62.68 |
| 2 | −325.514247 | 11.107993 | | 62.91 |
| 3 | 129.488132 | 17.508649 | CAF2 | 60.46 |
| 4 | 229.639040 | 19.117898 | | 58.15 |
| 5 | −297.616949 | 12.000000 | CAF2 | 56.83 |
| 6 | 137.266464 | 20.271243 | | 55.02 |
| 7 | −315.382299 | 10.000000 | CAF2 | 55.60 |
| 8 | 195.501672 | 33.775184 | | 59.45 |
| 9 | −100.921658 | 29.838102 | CAF2 | 61.40 |
| 10 | −142.534923 | 1.000000 | | 77.34 |
| 11 | −798.012567 | 27.726296 | CAF2 | 87.45 |
| 12 | −200.145009 | 1.000000 | | 91.28 |
| 13 | 544.360480 | 39.418448 | CAF2 | 100.59 |
| 14 | −302.135330 | 1.000000 | | 101.91 |
| 15 | 241.858895 | 27.376490 | CAF2 | 100.63 |
| 16 | 830.048522 | 1.000000 | | 98.59 |
| 17 | 103.113823 | 74.999559 | CAF2 | 88.78 |
| 18 | 100.002042 | 36.496056 | | 61.27 |
| 19 | 200.014028 | 12.000000 | CAF2 | 50.30 |
| 20 | 110.594821 | 23.278740 | | 44.14 |
| STO | 0.000000 | 58.126083 | | 38.96 |
| 22 | −1591.181299 | 12.000000 | CAF2 | 54.76 |
| 23 | 378.437060 | 14.524814 | | 58.01 |
| 24 | −1301.666458 | 32.936385 | CAF2 | 61.55 |
| 25 | −99.999186 | 8.787042 | | 64.48 |
| 26 | 617.185251 | 20.086580 | CAF2 | 63.86 |
| 27 | −267.481965 | 31.362211 | | 63.59 |
| 28 | 162.337936 | 23.708027 | CAF2 | 54.67 |
| 29 | −289.299752 | 0.099926 | | 52.43 |
| 30 | 216.227868 | 17.216831 | CAF2 | 47.14 |
| 31 | −285.863172 | 1.619177 | | 43.72 |
| 32 | −225.830235 | 29.947871 | CAF2 | 42.94 |
| 33 | 100.000914 | 19.999795 | | 30.08 |
| 34 | 0.000000 | 0.000000 | | 31.83 |
| 35 | 0.000000 | 309.774627 | | 31.83 |
| 36 | −1154.300735 | 15.000000 | CAF2 | 149.89 |
| 37 | 0.000000 | −15.000000 | REFL | 157.10 |
| 38 | −1154.300735 | −309.774627 | | 164.81 |
| 39 | 510.711652 | 309.774627 | REFL | 299.64 |
| 40 | −1154.300735 | 15.000000 | CAF2 | 140.27 |
| 41 | 0.000000 | 48.847908 | | 131.98 |
| 42 | 248.113516 | 30.274420 | CAF2 | 89.92 |
| 43 | 12494.746198 | 1.462282 | | 83.24 |
| 44 | 285.498948 | 71.886418 | CAF2 | 72.08 |
| 45 | 199.982095 | 4.699704 | | 28.24 |
| 46 | 0.000000 | 10.000000 | CAF2 | 24.48 |
| 47 | 0.000000 | 4.000000 | | 18.55 |
| 48 | 0.000000 | 0.000000 | | 13.30 |

Calculation Formula for Aspheres:

$$p ( h ) = \frac{ρ {h}^{2}}{1 + \sqrt{1 - ( 1 + K ) {ρ}^{2} {h}^{2}}} + {\sum }_{i = 1}^{n} {C}_{i} {h}^{2 i + 2}$$

p: rise (lens surface coordinate measured parallel to lens axis)
h: height (lens surface coordinate measured perpendicular to lens axis)
ρ: surface curvature radius at center of lens
Cᵢ: aspheric constants

Aspheric Constants for Objective of FIG. 1

| | Surface | | | |
|---|---|---|---|---|
| | 8 | 19 | 26 | 36 |
| K | 0 | 0 | 0 | 0 |
| C1 | −1.549740E−08 | −1.460624E−07 | −7.249474E−08 | 2.775685E−09 |
| C2 | −5.577528E−12 | −1.619036E−11 | 1.126023E−12 | −1.659211E−14 |
| C3 | 7.749141E−17 | 6.444489E−15 | 1.133607E−16 | −7.178059E−19 |
| C4 | 2.198916E−22 | −6.176896E−19 | −5.276658E−21 | 2.084770E−23 |
| C5 | −2.380676E−25 | 2.490795E−23 | 2.724793E−24 | −3.120285E−28 |
| | Surface | | | |
| | 38 | 39 | 42 | 45 |
| K | 0 | 0 | 0 | 0 |
| C1 | 2.775685E−09 | 2.917992E−11 | 3.423192E−08 | −2.695744E−07 |
| C2 | −1.659211E−14 | 8.910305E−17 | −1.681977E−12 | −2.978335E−11 |
| C3 | −7.178059E−19 | 1.170794E−22 | 5.067902E−17 | 4.588750E−14 |
| C4 | 2.084770E−23 | 3.747823E−27 | −2.196496E−21 | −1.486170E−17 |
| C5 | −3.120285E−28 | −2.354248E−32 | 1.013426E−25 | 2.257343E−21 |

TABLE 2
Design Data for the Objective of FIG. 2
Wavelength 157.6 nm

| Surface | Radius | Thickness | Glass | Semidiameter |
|---|---|---|---|---|
| 101 | 0.000000 | 0.000000 | CAF2 | 120.62 |
| 102 | 0.000000 | 32.000000 | | 120.62 |
| 103 | 274.106512 | 55.000000 | CAF2 | 133.59 |
| 104 | 1818.537748 | 231.146620 | | 131.56 |
| 105 | −1089.336166 | 30.000000 | CAF2 | 106.85 |
| 106 | −524.710448 | 26.283506 | | 106.06 |
| 107 | −186.233119 | 17.000000 | CAF2 | 105.41 |
| 108 | 451.306897 | 28.402104 | | 115.37 |
| 109 | 769.009721 | 57.596907 | CAF2 | 125.15 |
| 110 | −257.873226 | 82.136421 | | 127.71 |
| 111 | 329.084015 | 50.647322 | CAF2 | 129.40 |
| 112 | −690.081854 | 1.000180 | | 127.69 |
| 113 | 153.946954 | 38.852808 | CAF2 | 107.63 |
| 114 | 306.808811 | 1.000000 | | 100.50 |
| 115 | 130.936124 | 20.000064 | CAF2 | 89.13 |
| 116 | 99.135324 | 44.701862 | | 75.01 |
| STO | 0.000000 | 2.462197 | | 69.31 |
| 118 | −291.412086 | 15.000000 | CAF2 | 73.07 |
| 119 | 468.355252 | 60.051241 | | 72.62 |
| 120 | 639.482976 | 32.146214 | CAF2 | 91.04 |
| 121 | −325.895346 | 73.634424 | | 92.62 |
| 122 | 493.419422 | 24.615647 | CAF2 | 96.73 |
| 123 | −1282.442604 | 112.023001 | | 96.19 |
| 124 | −136.918864 | 29.655395 | CAF2 | 89.43 |
| 125 | −144.410348 | 1.000000 | | 96.16 |
| 126 | 280.473252 | 38.819964 | CAF2 | 93.22 |
| 127 | −385.988130 | 1.000000 | | 91.96 |
| 128 | 193.018607 | 29.943395 | CAF2 | 82.88 |
| 129 | −1524.052862 | 1.000000 | | 80.56 |
| 130 | 105.885060 | 47.217370 | CAF2 | 67.70 |
| 131 | 141.471143 | 1.000000 | | 52.28 |
| 132 | 115.643836 | 75.817929 | CAF2 | 51.07 |
| 133 | 0.000000 | −75.817929 | REFL | 32.28 |
| 134 | 115.643836 | 75.817929 | REFL | 64.13 |
| 135 | 0.000000 | 5.000000 | | 35.14 |
| 136 | 0.000000 | 0.000000 | | 30.16 |

Aspheric Constants for Objective of FIG. 2

| | Surface | | | | |
|---|---|---|---|---|---|
| | 103 | 106 | 108 | 114 | 123 |
| K | 0 | 0 | 0 | 0 | 0 |
| C1 | −5.244442E−10 | −1.007758E−08 | 2.566111E−08 | 9.436418E−09 | 1.362883E−08 |
| C2 | 2.752169E−13 | 1.047829E−12 | −1.805564E−12 | 1.951885E−13 | 1.156200E−13 |
| C3 | −1.473077E−17 | −2.207343E−17 | 6.884225E−17 | 3.734532E−18 | −1.317296E−17 |
| C4 | 4.202562E−22 | 3.926213E−22 | −1.726206E−21 | −1.570369E−22 | 1.486724E−22 |
| C5 | −4.785568E−27 | 1.262200E−26 | 2.174598E−26 | 2.106497E−26 | −3.868144E−26 |

Surface

| | 125 | 126 | 129 | 134 |
|---|---|---|---|---|
| K | 0 | 0 | 0 | 0 |
| C1 | 2.529549E−08 | −1.914007E−08 | −2.667717E−10 | −2.549619E−08 |
| C2 | −7.266840E−13 | 6.594817E−13 | 3.418971E−12 | −1.371560E−12 |
| C3 | 4.052314E−17 | −2.791930E−17 | −1.847526E−16 | −1.349333E−16 |
| C4 | 2.755929E−22 | 7.257841E−22 | 7.893448E−22 | 2.604124E−21 |
| C5 | 7.471684E−26 | 2.615572E−27 | 2.334365E−25 | −5.347848E−25 |

TABLE 3
Design Data for the Objective of FIG. 4
Wavelength 157.6 nm

| SURFACE | RADIUS | THICKNESS | GLASS | SEMIDIAM. |
|---|---|---|---|---|
| 200 | 0.000000 | 32.000000 | | 128.40 |
| 201 | 274.860016 | 46.781484 | CAF2 | 141.32 |
| 202 | 3340.544295 | 217.336921 | | 140.21 |
| 203 | −929.703795 | 15.000000 | CAF2 | 109.08 |
| 204 | −641.673508 | 35.917728 | | 108.45 |
| 205 | −184.303015 | 15.000000 | CAF2 | 106.38 |
| 206 | 438.593542 | 33.462599 | | 115.76 |
| 207 | 801.406574 | 55.175300 | CAF2 | 127.81 |
| 208 | −259.419530 | 82.096109 | | 129.95 |
| 209 | 332.682487 | 49.838491 | CAF2 | 133.15 |
| 210 | −729.281098 | 9.001651 | | 131.75 |
| 211 | 165.527343 | 33.551933 | CAF2 | 110.27 |
| 212 | 332.867167 | 1.000000 | | 105.11 |
| 213 | 133.964421 | 20.000000 | CAF2 | 93.26 |
| 214 | 107.874083 | 49.073593 | | 80.40 |
| 215 | 0.000000 | 4.853072 | | 73.45 |
| 216 | −361.376349 | 10.000000 | CAF2 | 75.05 |
| 217 | 278.395676 | 78.982814 | | 76.62 |
| 218 | 481.613226 | 37.384443 | CAF2 | 107.46 |
| 219 | −397.063623 | 55.300129 | | 108.89 |
| 220 | 386.540779 | 30.002246 | CAF2 | 114.67 |
| 221 | −2629.775253 | 125.310493 | | 113.98 |
| 222 | −130.188723 | 30.000000 | CAF2 | 102.80 |
| 223 | −147.807663 | 18.653604 | | 112.36 |
| 224 | 415.465955 | 34.926605 | CAF2 | 106.86 |
| 225 | −360.057660 | 1.000000 | | 106.15 |
| 226 | 182.153609 | 38.453381 | CAF2 | 94.41 |
| 227 | −2229.972920 | 1.000000 | | 91.17 |
| 228 | 119.071995 | 42.088684 | CAF2 | 75.18 |
| 229 | 154.299879 | 7.674655 | | 60.05 |
| 230 | 124.347466 | 41.631513 | CAF2 | 55.73 |
| 231 | 872.416562 | 2.000000 | | 43.58 |
| 232 | 700.993542 | 39.601615 | CAF2 | 42.69 |
| 233 | 0.000000 | −39.601615 | REFL | 34.38 |
| 234 | 700.993542 | −2.000000 | | 49.01 |
| 235 | 872.416562 | −41.631513 | CAF2 | 52.98 |
| 236 | 124.347466 | 41.631513 | REFL | 69.88 |
| 237 | 872.416562 | 2.000000 | | 58.29 |
| 238 | 700.993542 | 39.601615 | CAF2 | 56.27 |
| 239 | 0.000000 | 5.000000 | | 37.13 |
| 240 | 0.000000 | 0.000000 | | 32.10 |

Aspheric Constants for Objective of FIG. 4

| | Surface | | | | |
|---|---|---|---|---|---|
| | 201 | 204 | 206 | 212 | 221 |
| K | 0 | 0 | 0 | 0 | 0 |
| C1 | −5.462701E−10 | −1.135701E−08 | 2.769405E−08 | 1.019091E−08 | 2.181845E−09 |
| C2 | 2.544727E−13 | 1.029074E−12 | −1.745363E−12 | 1.488027E−13 | −8.269428E−14 |
| C3 | −1.434079E−17 | −2.906629E−17 | 6.735802E−17 | 3.267005E−18 | −8.651234E−18 |
| C4 | 4.460697E−22 | 5.650323E−22 | −1.790183E−21 | −1.060147E−22 | 2.013228E−22 |
| C5 | −5.278879E−27 | 3.739118E−27 | 2.359794E−26 | 1.708077E−26 | −2.843967E−26 |

Surface

| | 223 | 224 | 227 | 236 |
|---|---|---|---|---|
| K | 0 | 0 | 0 | 0 |
| C1 | 1.149047E−08 | −3.314391E−08 | −1.070627E−08 | −2.460448E−08 |
| C2 | −1.188725E−12 | −6.989937E−13 | 1.584658E−12 | −1.676555E−12 |
| C3 | 6.600996E−17 | 5.345553E−18 | −2.040430E−16 | −1.016098E−16 |
| C4 | −2.073994E−21 | 1.780910E−21 | 1.528880E−20 | −3.481394E−21 |
| C5 | 3.827477E−26 | −5.901471E−26 | −4.322147E−25 | −5.328509E−25 |

1. (canceled)

2. The system of claim 6, wherein the system is aligned and centered on an unbroken and single optical axis.

3. The system of claim 6, wherein the first optical subsystem is a purely refractive subsystem.

4. The system of claim 6, wherein the third optical subsystem is a purely refractive subsystem.

5. The system of claim 6, wherein the first optical subsystem forms an intermediate image, substantially at said central passage opening.

6. A catadioptric objective for a microlithography projection system with an object plane and an image plane, wherein the objective comprises in sequential order relative to a spatial direction from the object plane to the image plane:
a first optical subsystem comprising a plurality of lenses;
a second optical subsystem comprising a concave mirror with a concave mirror surface facing towards the image plane and with a central passage opening for said light path, and further comprising a catadioptric lens element with a first surface nearer to the object plane and a second surface nearer to the image plane; and
a third optical subsystem comprising at least one lens;
wherein light rays propagating along a light path from the object plane to the image plane:
pass through the first optical subsystem
pass through said first surface of the catadioptric lens element;
are at least partially reflected by said second surface of said catadioptric lens element, and pass again through said first surface;
are reflected by the concave mirror;
pass a third time through the catadioptric lens element;
are at least partially transmitted by said second surface of said catadioptric lens element; and
are focused by the third optical subsystem to form an image in the image plane,
wherein said second surface of said catadioptric lens element is coated with a beam splitter coating.

7. The objective of claim 6, wherein the catadioptric lens element has a negative refractive power.

8. The objective of claim 6, wherein the at least partial reflection by the beam splitter coating is a substantially total reflection and the at least partial transmission by the beam splitter coating is a substantially total transmission.

9. The objective of claim 6, wherein the beam splitter coating is a 50-percent beam splitter, so that substantially one-half of incident light is reflected and one-half of incident light is transmitted.

10. The objective of claim 6, wherein one of said first surface and said second surface of the catadioptric lens element has a central light barrier configured as a black spot, to prevent that light rays arriving from said central passage opening reach the image plane directly without having been reflected by the beam splitter coating and the concave mirror.

11. The objective of claim 10, further comprising a peripheral light barrier between the third optical subsystem and the image plane, wherein said peripheral light barrier is coordinated with said central light barrier in regard to shape and dimensions.

12. The objective of claim 6, further comprising a system diaphragm arranged in the first optical subsystem.

13. The objective of claim 12, wherein the system diaphragm and the concave mirror are located essentially at mutually conjugate positions.

14. The objective of claim 6, further comprising a system diaphragm arranged near the concave mirror surface, wherein the system diaphragm has a substantially spherical shape and a variable aperture diameter and is centered on the curvature center of the concave mirror.

15. The objective of claim 6, wherein the plurality of lenses of the first optical subsystem, the catadioptric lens element, and the at least one lens of the third optical subsystem are made of identical lens material.

16. The objective of claim 6, wherein at least one of the lenses in the first optical subsystem, the catadioptric lens element, and the third optical subsystem is made of a crystalline lens material.

17. The objective of claim 16, wherein the crystalline lens material comprises calcium fluoride.

18. The objective of claim 6, wherein substantially all of the lenses of the first optical subsystem, the catadioptric lens element, and the at least one lens of the third optical subsystem are made of silicon dioxide, except for lenses that are sensitive to at least one of the group of adverse effects consisting of lens heating, degradation, and compaction.

19. The objective of claim 6, wherein substantially all of the lenses in the first optical subsystem, the catadioptric lens element, and the third optical subsystem are made of calcium fluoride.

20. The objective of claim 6, wherein the objective operates with non-polarized ultraviolet light.

21. The objective of claim 20, wherein said ultraviolet light has a wavelength not exceeding 260 nanometers.

22. The objective of claim 21, wherein said wavelength is substantially one of 157 nanometers and 193 nanometers.

23. The objective of claim 6, wherein the objective has a linear central obscuration of less than 15 percent.

24. The objective of claim 23, wherein said linear central obscuration does not exceed twelve percent.

25. A catadioptric objective for a microlithography projection system with an object plane and an image plane, wherein the objective comprises in sequential order relative to a spatial direction from the object plane to the image plane:
a first optical subsystem comprising a plurality of lenses;
a second optical subsystem comprising a concave mirror with a concave mirror surface facing towards the image plane and with a central passage opening for said light path, and further comprising a catadioptric lens element with a first surface nearer to the object plane and a second surface nearer to the image plane; and
a third optical subsystem comprising at least one lens;
wherein light rays propagating along a light path from the object plane to the image plane:
pass through the first optical subsystem
pass through said first surface of the catadioptric lens element;
are at least partially reflected by said second surface of said catadioptric lens element, and pass again through said first surface;
are reflected by the concave mirror;
pass a third time through the catadioptric lens element;
are at least partially transmitted by said second surface of said catadioptric lens element; and
are focused by the third optical subsystem to form an image in the image plane,
wherein the objective operates with non-polarized ultraviolet light
wherein said ultraviolet light has a wavelength not exceeding 260 nanometers
wherein the objective has a numerical aperture NA of at least 0.85 and a wave-front variation with an rms-value of less than 3/1000 relative to said wavelength.

26. The objective of claim 25, wherein a refractive immersion fluid is arranged on an image side of the objective, and wherein the objective has a numerical aperture larger than 1.0.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. A catadioptric objective for a microlithography projection system with an object plane and an image plane, wherein the objective comprises in sequential order relative to a spatial direction from the object plane to the image plane:
a first optical subsystem;
a second optical subsystem comprising a first Mangin lens having a first surface nearer to and convex-curved towards the object plane, wherein said first surface has a first light-transmitting portion and further has a first mirror portion reflective towards an interior of the first Mangin lens; and further comprising a second Mangin lens having a second surface nearer to the image plane, wherein said second surface has a second light-transmitting portion and further has a second mirror portion reflective towards an interior of the second Mangin lens;
wherein light rays propagating along a light path from the object plane to the image plane:
are focused by the first optical subsystem;
pass through the first light-transmitting portion, the first Mangin lens and the second Mangin lens;
are reflected by the second mirror portion, then pass through the second Mangin lens and the first Mangin lens;
are reflected by the first mirror portion, then pass through the first Mangin lens and the second Mangin lens;
exit from the second Mangin lens through the second light-transmitting portion, having been focused as a result of passing three times through the first and second Mangin lenses so as to form an image in the image plane,
wherein a refractive immersion fluid is arranged on an image side of the objective, and wherein the objective has a numerical aperture larger than 1.0.

43. (canceled)

44. The objective of claim 42, wherein an overall system magnification is defined as β, wherein a refractive magnification contributed by the first optical subsystem is defined as β1, and wherein 4/3<|β1/β|<3.

45. The objective of claim 42, wherein the first and second optical subsystems have lenses made of identical lens material.

46. The objective of claim 42, wherein the first and second optical subsystems comprise at least one lens made of a crystalline lens material.

47. The objective of claim 46, wherein the crystalline lens material comprises calcium fluoride.

48. The objective of claim 42, wherein the first and second optical subsystems comprise lenses made of silicon dioxide, except for lenses that are sensitive to at least one of the group of adverse effects consisting of lens heating, degradation, and compaction.

49. The objective of claim 42, wherein the first and second optical subsystems comprise lenses, substantially all of which are made of calcium fluoride.

50. The objective of claim 42, wherein the objective operates with non-polarized ultraviolet light.

51. (canceled)

52. (canceled)

53. (canceled)

54. (canceled)

55. (canceled)

56. The objective of claim 25, wherein the at least partial reflection by the beam splitter coating is a substantially total reflection and the at least partial transmission by the beam splitter coating is a substantially total transmission.

57. The objective of claim 25, wherein the beam splitter coating is a 50-percent beam splitter, so that substantially one-half of incident light is reflected and one-half of incident light is transmitted.

58. The objective of claim 25, wherein one of said first surface and said second surface of the catadioptric lens element has a central light barrier configured as a black spot, to prevent that light rays arriving from said central passage opening reach the image plane directly without having been reflected by the beam splitter coating and the concave mirror.

59. The objective of claim 58, further comprising a peripheral light barrier between the third optical subsystem and the image plane, wherein said peripheral light barrier is coordinated with said central light barrier in regard to shape and dimensions.

60. The objective of claim 6, wherein a refractive immersion fluid is arranged on an image side of the objective, and wherein the objective has a numerical aperture larger than 1.0.
